(19) United States
(12) Patent Application Publication
(10) Pub. No.: US 2026/0279632 A1
(43) Pub. Date: Sep. 17, 2026

(54) INDUCTOR

(71) Applicant: Murata Manufacturing Co., Ltd., Kyoto-fu (JP)

(72) Inventors: Akiumi OBA, Nagaokakyo-shi (JP); Kouhei OSAKI, Nagaokakyo-shi (JP); Yusuke AKAKI, Nagaokakyo-shi (JP); Yasushi YUNOKI, Nagaokakyo-shi (JP); Shoichiro FURUKAWA, Nagaokakyo-shi (JP); Daisuke ISHIDA, Nagaokakyo-shi (JP); Yutaka NOGUCHI, Nagaokakyo-shi (JP); Yoshiko BANNO, Nagaokakyo-shi (JP); Mikito SUGIYAMA, Nagaokakyo-shi (JP); Kazuhiro NAKAMURA, Nagaokakyo-shi (JP)

(73) Assignee: Murata Manufacturing Co., Ltd., Kyoto-fu (JP)

(21) Appl. No.: 19/669,664

(22) Filed: May 6, 2026

Related U.S. Application Data
(63) Continuation of application No. PCT/IB2025/050484, filed on Jan. 16, 2025.
(60) Provisional application No. 63/622,363, filed on Jan. 18, 2024.

(51) Int. Cl. H01F 1/26; H01F 27/28; H01F 27/29; H01F 27/32

(52) U.S. Cl. CPC H01F 1/26; H01F 27/2852; H01F 27/29; H01F 27/324

(57) ABSTRACT

An inductor comprising a body including a resin that includes first magnetic metal particles having a first diameter, a first coil and a second coil inside the body, and a first portion in the body between the first coil and the second coil in a stacking direction of the first coil and the second coil. The first portion extends between the first coil and the second coil along a first direction which is transverse to the stacking direction. The first portion includes second magnetic metal particles having a second diameter that is smaller than the first diameter. A border area where the first portion and a second portion of the body meet includes extending areas where the first portion extends further into the second portion of the body along the first direction than other areas of the first portion in the border area such that the first portion and the second portion mesh with each other.

### CROSS-REFERENCE TO RELATED APPLICATION

This application is a Continuation of International Patent Application No. PCT/IB2025/050484, filed Jan. 16, 2025 and to U.S. Provisional Application No. 63/622,363, filed Jan. 18, 2024, the entire content of which is incorporated herein by reference.

### BACKGROUND

### Technical Field

The present disclosure relates to an inductor. More particularly, the present disclosure relates to a multilayer inductor having multiple coils.

### Background Art

A multilayer inductor typically includes coils disposed inside an element body having insulating properties. The coil includes, for example, a plurality of coil wiring layers stacked with insulating layers interposed therebetween. These coil wiring layers can be electrically connected to terminals on a surface of the element body.

### SUMMARY

Accordingly, an inductor according to the present disclosure comprises a first coil and a second coil inside the body in a stacking direction, and a first portion in the body between the first coil and the second coil in the stacking direction of the first coil and the second coil. The first portion extends between the first coil and the second coil along a first direction which is transverse to the stacking direction. The first portion includes second magnetic metal particles having a second diameter that is smaller than the first diameter. A border area where the first portion and a second portion of the body meet includes extending areas where the first portion extends further into the second portion of the body along the first direction than other areas of the first portion in the border area such that the first portion and the second portion mesh with each other.

In addition, an inductor according to the present disclosure comprises a body including a resin that includes magnetic metal particles, a coil inside the body, a pad on a surface of the body that is electrically connected to the coil, and an outer surface of the pad includes protruding portions and recessed portions. The inductor further includes an outer electrode that is on the surface of the body. The outer electrode contacts the outer surface of the pad and is electrically connected to the pad, such that the protruding portions of the pad extend into the outer electrode and portions of the outer electrode extend into the recessed areas of the pad.

Other features, elements, characteristics and advantages of the present disclosure will become more apparent from the following detailed description of some embodiments of the present disclosure with reference to the attached drawings.

### BRIEF DESCRIPTION OF THE DRAWINGS

FIG. 1 is a perspective, diagonal view schematically illustrating an example of the multilayer inductor according to the present disclosure;

FIG. 2 is an elevational view of the multilayer inductor shown in FIG. 1 in a direction of the L axis;

FIG. 3 is an elevational view of the multilayer indictor shown in FIG. 1 in a direction of the W axis;

FIG. 4 is an plan view of the multilayer inductor shown in FIG. 1 in a direction of the T axis;

FIGS. 5A and 5B are photographic images of a cross-section of the multilayer inductor taken along lines I-I in FIG. 2 in a right-hand view, illustrating an example of the resin filling rate of the body above the first coil, between the first coil and the second coil, and below the second coil;

FIGS. 6A to 6C are photographic images of the cross-section of the multilayer inductor in FIGS. 5A and 5B showing enlarged images at locations along a via and a pad;

FIG. 7 are photographic images of the cross-section of the multilayer inductor in FIGS. 5A and 5B showing enlarged images at locations in the upper outer layer, between the first connection portion and the second connection portion, and in the lower outer layer;

FIG. 8 are photographic images of the six surfaces of the multilayer inductor shown in FIGS. 1-4;

FIG. 9 are photographic images illustrating magnetic metal particles at the surfaces of the multilayer inductor shown in FIGS. 1-4;

FIG. 10 are photographic images of the surfaces of the multilayer inductor shown in FIGS. 1-4;

FIG. 11 is a photographic image of a cross-section of the multilayer inductor taken along lines II-II in FIG. 2 in a right-hand view;

FIG. 12 is a graph showing examples of differences between L values of the first coil and the second coil, and differences between the L values of the third coil and the fourth coil, of the multilayer inductor shown in FIGS. 1-4;

FIG. 13 is a photographic image of a cross-section of the multilayer inductor taken along lines III-III in FIG. 2 in a lower left view;

FIG. 14 are photographic images of a cross-section of the multilayer inductor taken along lines I-I in FIG. 2 in a right-hand view as in FIGS. 5A and 5B;

FIG. 15 are photographic images of an overlapping portion of a small particle portion and the second portion of the multilayer inductor shown in FIGS. 1-4;

FIG. 16 is an enlarged view illustrating a zigzag boundary between the small particle portion and the body as shown in FIG. 15;

FIG. 17 is a cross-sectional view of the multilayer inductor taken along lines IV-IV in FIG. 3 in a right-hand view;

FIGS. 18A to 18C are photographic images of peroxide of magnetic metal particles and diffusion of Ag in the multilayer inductor shown in FIGS. 1-4;

FIG. 19 are photographic images of the body, the small particle portion and interfaces between the body, the small particle portion and the coils of the multilayer inductor shown in FIGS. 1-4;

FIG. 20 are photographic images of pads, outer electrodes, a protective layer and the body of the multilayer inductor shown in FIGS. 1-4;

FIG. 21 are photographic images taken along lines V-V in FIG. 4 in a right-hand view illustrating features of the multilayer inductor shown in FIGS. 1-4;

FIG. 22 are photographic images taken along lines V-V in FIG. 4 in a right-hand view illustrating features of the multilayer inductor shown in FIGS. 1-4; and

FIG. 23 is an enlarged version of the photographic image taken along lines V-V in FIG. 4 as shown in FIG. 21.

### DETAILED DESCRIPTION

Hereinafter, an embodiment of an inductor component will be described. Note that, in some cases, constituent elements in the accompanying drawings are illustrated in an enlarged manner for the sake of easy understanding. The dimensional ratio of the constituent elements may differ from the actual one or that in another figure. In addition, although hatching is given in a cross-sectional view, hatching of some constituent elements may be omitted for the sake of easy understanding.

A multilayer inductor according to the present disclosure will hereinafter be described.

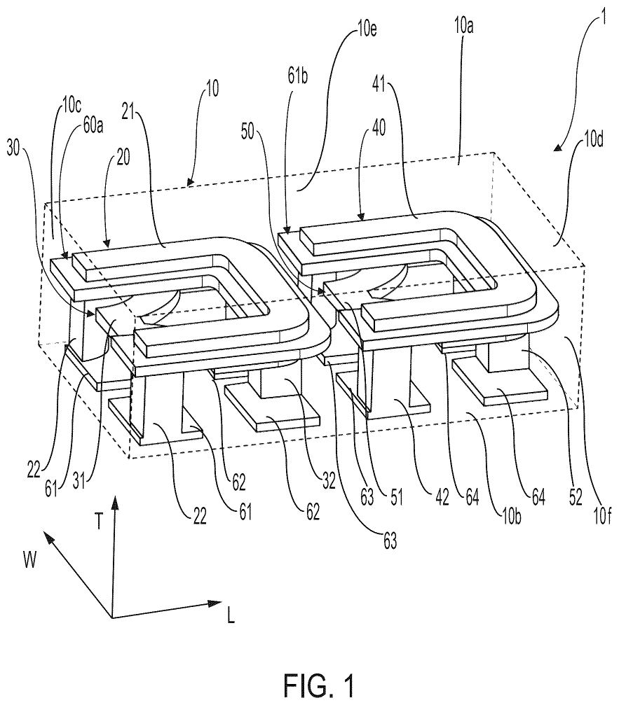

FIGS. 1-4 illustrate an embodiment of a multilayer inductor 1 according to an embodiment of the present disclosure. As illustrated in FIG. 1, the multilayer inductor 1 includes a body 10, and a first coil 20, a second coil 30, a third coil 40, and a fourth coil 50, which are referred to commonly as “coils.” As further shown in FIGS. 1-4, the longitudinal direction, the transverse direction, and the height direction of the multilayer inductor 1 and the body 10 are referred to as an L direction, a W direction, and a T direction, respectively. In the present specification, a direction in which sheets are stacked during manufacturing is referred to as a “stacking direction,” which is the T direction in FIGS. 1-4.

Each of the coils includes two vias that extend in the T direction and that are connected to the pads and a connection portion that extends in the W direction and the L direction and that connects the vias to each other. That is, the first coil 20 includes two first vias 22 and a first connection portion 21 that connects the first vias 22 to each other. The second coil 30 includes two second vias 32 and a second connection portion 31 that connects the second vias 32 to each other. The third coil 40 includes two third vias 42 and a third connection portion 41 that connects the third vias 42 to each other. The fourth coil 50 includes two fourth vias 52 and a fourth connection portion 51 that connects the fourth vias 52 to each other. The first coil 20, second coil 30, third coil 40, and fourth coil 50 are located in the body 10.

The multilayer inductor 1 further includes a small particle portion 60a between the first coil 20 and the second coil 30. The first vias 22 extend through the small particle portion 60a and connect to opposite ends of the first connection portion 21. Also, the multilayer inductor 1 includes a small particle portion 60b between the third coil 40 and the fourth coil 50. The fourth vias 52 extend through the small particle portion 60b and connect to opposite ends of the third connection portion 41. The small particle portions 60a and 60b are discussed in more detail below. The small particle portion is also called a first portion or a 2 μm portion.

The multilayer inductor 1 further includes and first pads 61, second pads 62, third pads 63, and fourth pads 64, which are referred to commonly as “pads” and are located in the body 10. The first pads 61 are connected to the first vias 22 of the first coil 20, the second pads 62 are connected to the second vias 32 of the second coil 30, the third pads 63 are connected to the third vias 42 of the third coil 40, and the fourth pads 64 are connected to the fourth vias 52 of the fourth coil 50.

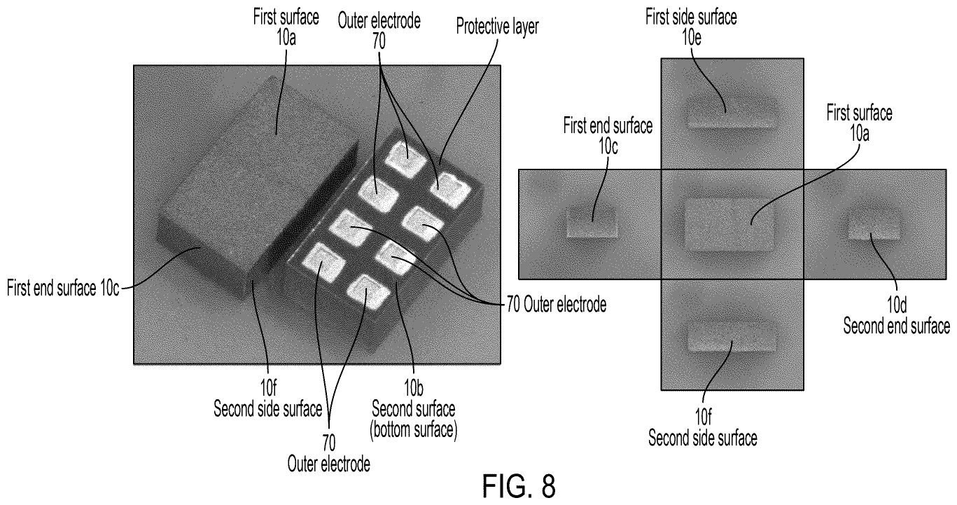

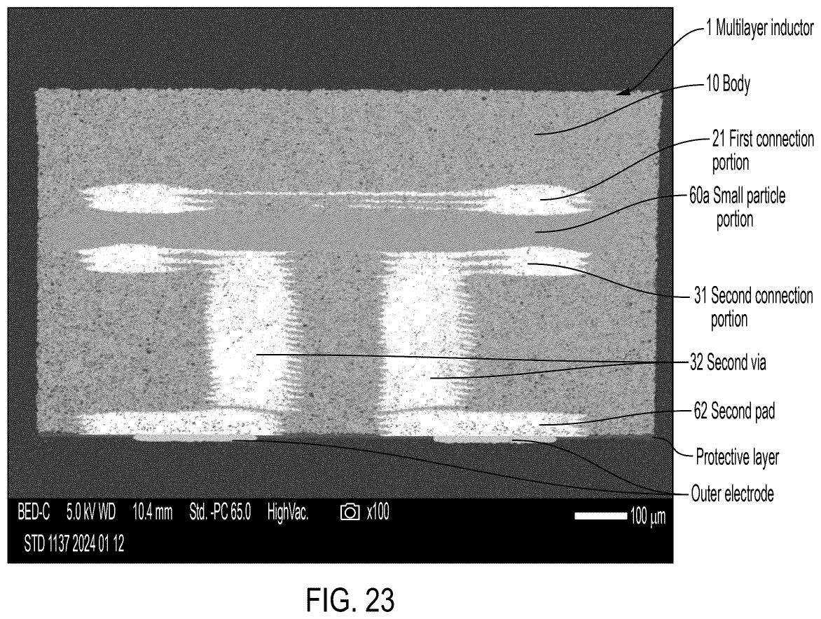

The first pads 61 have surfaces that are exposed from the body 10, the second pads 62 have surfaces that are exposed from the body 10, the third pads 63 have surfaces that are exposed from the body 10, and the fourth pads 64 have surfaces 64-1 that are exposed from the body 10. The exposed surfaces of the first pads 61 contact respective outer electrodes 70 that are formed on the surface of the body 10 and discussed in more detail below with respect to, for example, FIGS. 8 and 21-23. Therefore, the first pads 61 connect the first coil 20 to those outer electrodes 70. Similarly, exposed surfaces of the second pads 62 contact respective outer electrodes 70 that are formed on the surface of the body 10, and therefore, the second pads 62 connect the second coil 30 to those outer electrodes 70. Also, exposed surfaces of the third pads 63 contact respective outer electrodes 70 that are formed on the surface of the body 10, and therefore, the third pads 63 connect the third coil 40 to those outer electrodes 70. Likewise, exposed surfaces of the fourth pads 64 contact respective outer electrodes 70 that are formed on the surface of the body 10, and therefore, the fourth pads 64 connect the fourth coil 50 to those outer electrodes 70.

These features of the multilayer inductor 1 will now be described in more detail.

### Body 10

As shown in the example in FIGS. 1-4, the body 10 has a hexahedron shape having six surfaces. An example may be a rectangular cuboid shape or a substantially rectangular cuboid shape. Also, one or more of the corner portions and one or more of the ridge line portions of the body 10 may be rounded. In addition, the body 10 is not limited to this shape, and can have any other suitable shape.

The body 10 illustrated in FIG. 1 has a first surface 10a and a second surface 10b that face away from each other in the height direction T, a first end surface 10c and a second end surface 10d that face away from each other in the longitudinal direction L, and a first side surface 10e and a second side surface 10f that face away from each other in the transverse direction W. In an example illustrated in FIG. 1, multiple outer electrodes 70 (specifically, eight as shown, for example, in FIG. 8) are formed only on the second surface 10b (bottom surface 10b). However, the outer electrodes 70 can be formed partially or entirely on other surfaces of the body 10, as appropriate. As discussed above, the multiple outer electrodes 70 are electrically connected to exposes surfaces of the first pads 61, the second pads 62, the third pads 63, and the fourth pads 64, which are exposed from the second surface 10b (bottom surface 10b) of the body 10 in this embodiment. The second surface 10b corresponds to a mounting surface (a bottom surface of the body) of the multilayer inductor 1 in this embodiment.

The body 10 contains magnetic metal particles. Specifically, the magnetic metal particles contain Fe. More specifically, Fe particles or Fe alloy particles are acceptable. Examples of an Fe alloy may include an Fe—Si alloy, an Fe—Si—Cr alloy, an Fe—Si—Al alloy, an Fe—Si—B—P—Cu—C alloy, and an Fe—Si—B—Nb—Cu alloy. The magnetic metal particles may contain impurities such as Cr, Mn, Cu, Ni, P, S, or Co that are not intentional for manufacturing. According to the present embodiment, the magnetic metal particles that are contained in the body 10 are composed of an Fe—Si alloy.

The surface of each magnetic metal particle described above may be covered by an insulating coating. With the surface of each magnetic metal particle covered by the insulating coating, insulation characteristics between the magnetic metal particles can be improved, the withstand voltage of the inductor 1 can be increased, and an eddy current can be inhibited from being generated at the magnetic metal particles. Examples of a method of forming the insulating coating on the surface of each magnetic metal particle can include a sol-gel method and a mechanical chemistry method. The material of the insulating coating may be an oxide of, for example, P or Si, a zinc phosphate, or a manganese phosphate. The insulating coating may be an oxide film that is formed by oxidizing the surface of each magnetic metal particle with oxygen in the atmosphere or an oxide coating of an element that is more likely to oxidize than Fe. The thickness of the insulating coating is preferably no less than 1 nm and no more than 50 nm (i.e., from 1 nm to 50 nm), more preferably no less than 1 nm and no more than 30 nm (i.e., from 1 nm to 30 nm), further preferably no less than 1 nm and no more than 20 nm (i.e., from 1 nm to 20 nm). For example, a section that is obtained by polishing a sample of the inductor 1 is photographed by a scanning electron microscope (SEM), and the thickness of the insulating coating that covers the surface of each magnetic metal particle can be measured from an obtained SEM photograph.

The average particle diameter of the magnetic metal particles is preferably no less than 1 μm and no more than 30 μm (i.e., from 1 μm to 30 μm), more preferably no less than 1 μm and no more than 20 μm (i.e., from 1 μm to 20 μm), further preferably no less than 1 μm and no more than 10 μm (i.e., from 1 μm to 10 μm). According to the present embodiment, the body 10 contains the magnetic metal particles having an average particle diameter of 5 μm. The average particle diameter of the magnetic metal particles in a magnetic layer can be measured through a procedure described below. A sample section is obtained by cutting the sample of the inductor 1. Specifically, the sample section is obtained by cutting a central portion of the body 10 in a direction perpendicular to the mounting surface and end surfaces of the multilayer inductor 1. As for the obtained section, regions (for example, 130 μm×100 μm) at multiple locations (for example, five locations) are photographed by the SEM, obtained SEM images are analyzed by using image analysis software (such as image analysis software WinROOF2021 (made by MITANI CORPORATION)), and the diameters of substantially circular shapes of the magnetic metal particles are obtained. The average value of the obtained diameters of the substantially circular shapes is used as the average particle diameter of the magnetic metal particles.

When the body 10 is formed, heat treatment is performed. In this case, oxide films are on the surfaces of the magnetic metal particles that are contained in the body 10. The oxide films are originated from the magnetic metal particles and are formed by the heat treatment. As for the body 10, the magnetic metal particles adjacent to each other may be joined to each other with the oxide films interposed therebetween. Thus, an oxide film is grown by the oxide derived from metal magnetic particles by heat treatment, and adjacent metal magnetic particles are joined to each other through the oxide film.

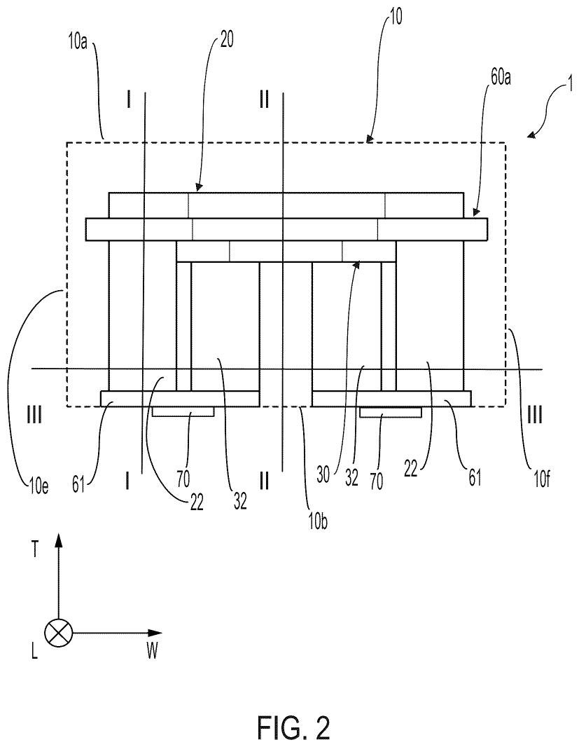

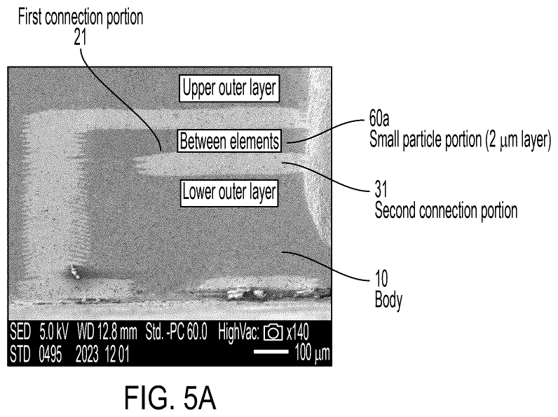

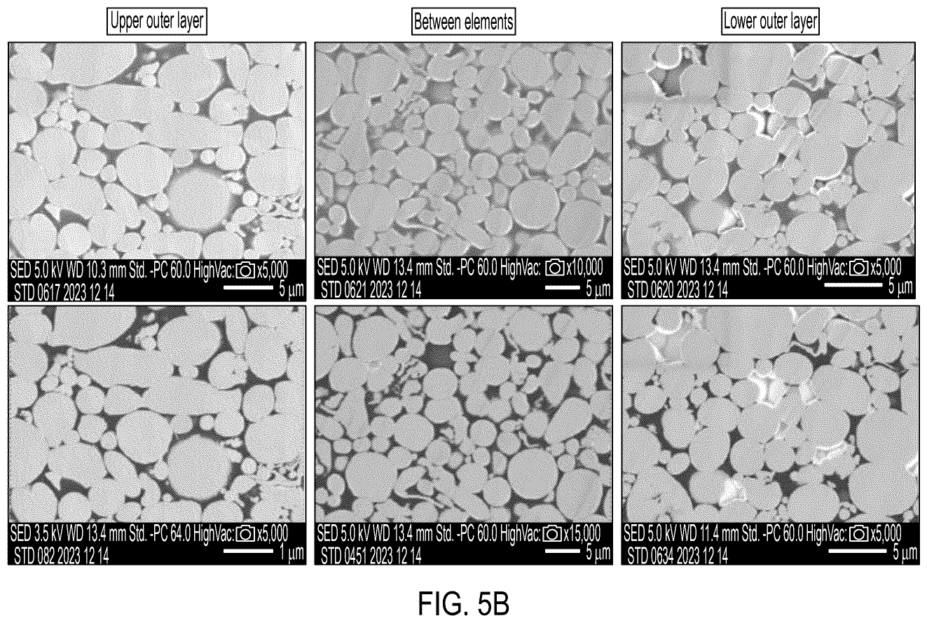

Concerning the body 10, resin may be impregnated after the body 10 is formed in order to improve strength. Thus, the resin may be interposed between the oxide films of the adjacent metal magnetic particles. An example of the resin for improving the strength of the body may be epoxy resin or/and phenolic resin or/and silicone resin. According to the present embodiment, resin may be impregnated in the body 10. The resin filling rate of the body 10 above the first coil 20 (an upper outer layer), between the first coil 20 and the second coil 30 (between elements), and below the second coil 30 (a lower outer layer) is illustrated in Table 1 below, and shown in FIG. 5A which is a cross-section taken along lines I-I in FIG. 2. The upper outer layer and lower outer layer are parts of the body 10.

TABLE 1
Resin filling rate [%]

| | |
|---|---|
| Upper outer layer | 98.5 |
| Between elements (first portion) | 99.0 |
| Lower outer layer | 64.7 |

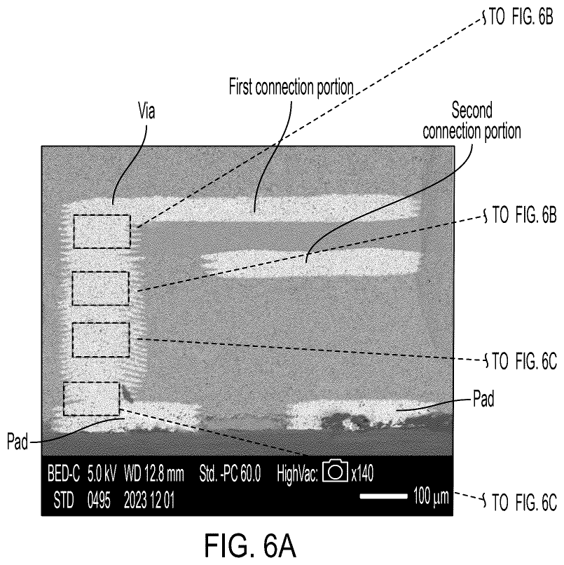

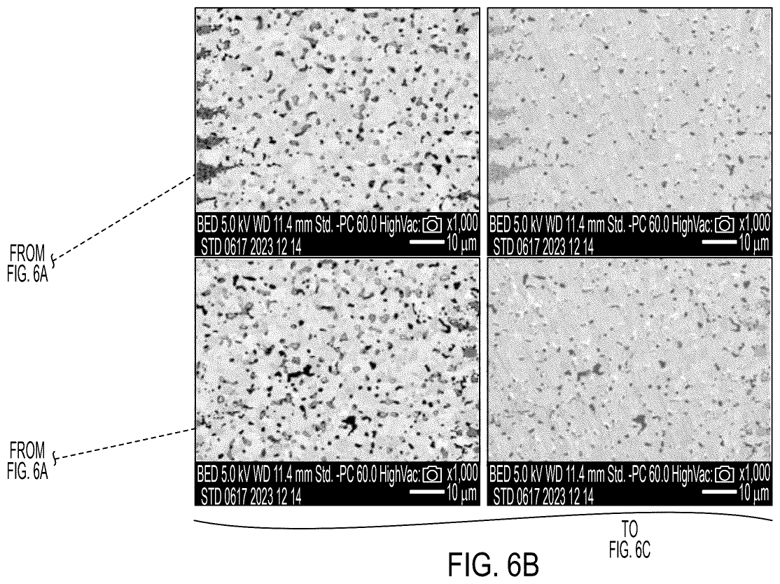

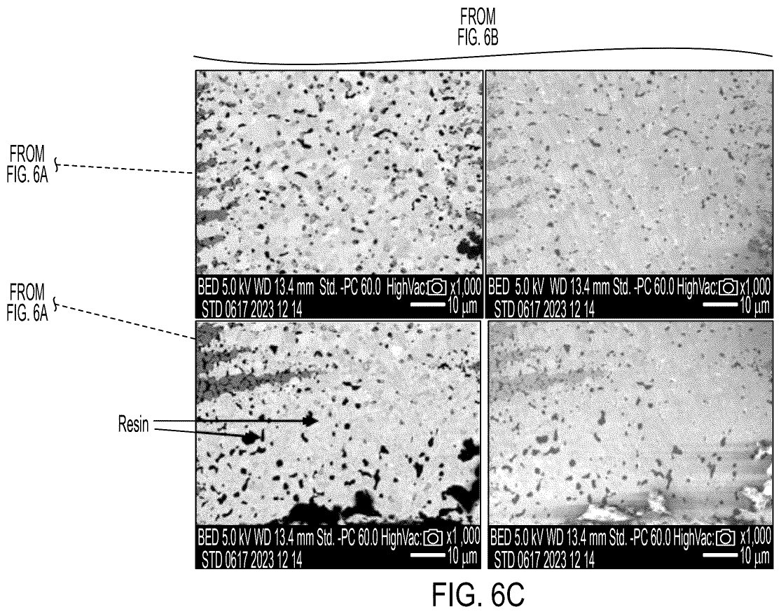

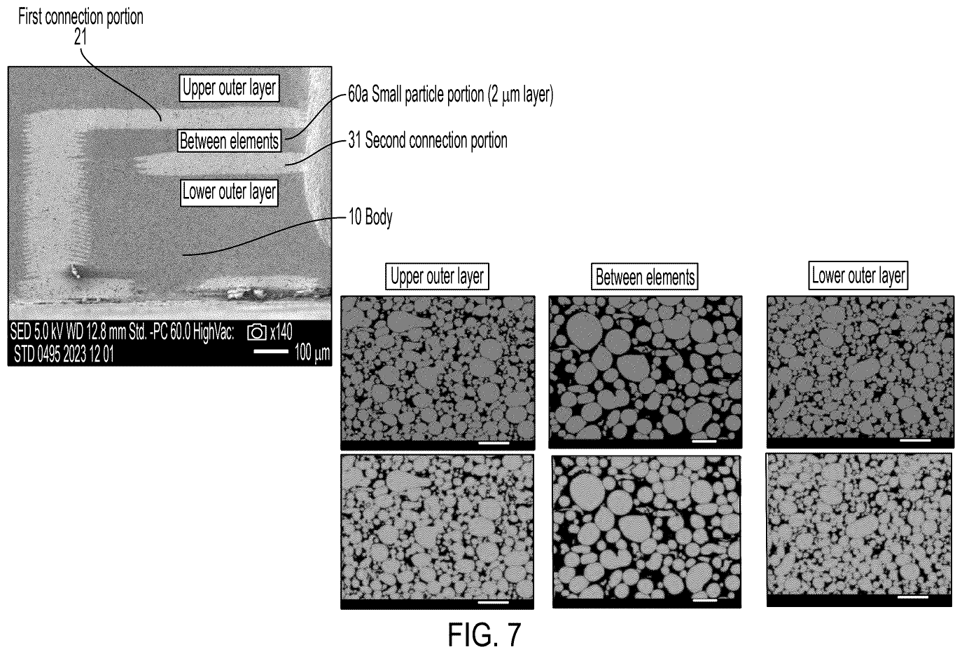

As illustrated in Table 1, the resin filling rate below the second coil 30 is lower than a resin filling rate above the first coil 20 (the upper outer layer) and between the first coil 20 and the second coil 30 (between the elements). The resin filling rate is a percentage of a portion corresponding to the resin to the whole of a ternary photograph of a section of the body. The SEM photograph of the cross section of the body is binarized and read into image software, and the resin filling rate is a ratio of the area of the portion corresponding to the resin to the area of a remaining part excluding the area of metallic magnetic particles. FIGS. 6A to 6C are photographic images of the cross-section of the multilayer inductor in FIGS. 5A and 5B showing enlarged images at locations along a via and a pad, and FIG. 7 are photographic images of the cross-section of the multilayer inductor in FIGS. 5A and 5B showing enlarged images at locations in the upper outer layer, between the first connection portion and the second connection portion, and in the lower outer layer. As illustrated in the photographic images of FIGS. 5A to 7, the resin may be filled in not only the body 10 but also the. vias 22, 32, 42 and 52, the connection portions 21, 31, 41 and 51, and the pads 61, 62, 63 and 64.

As illustrated in Table 2 and the photographic images of FIGS. 5A to 7, the area between elements and the lower outer layer, a metal filling rate between the first coil 20 and the second coil 30 (between the elements) is lower than the metal filling rate above the first coil 20 (the upper outer layer) and below the second coil 30 (the lower outer layer). This enables the withstand voltage of the multilayer inductor 1 to be increased.

TABLE 2
Metal filling rate [%]

| | |
|---|---|
| Upper outer layer | 78.2 |
| Between elements (first portion) | 71.2 |
| Lower outer layer | 77.4 |

A metal filling rate is a percentage of the area of a portion corresponding to the magnetic metal particles to the whole of a ternary photograph of a section of the body 10. A metal filling rate is calculated, for example, by that the SEM photograph of the cross section of the body is binarized and read into image software.

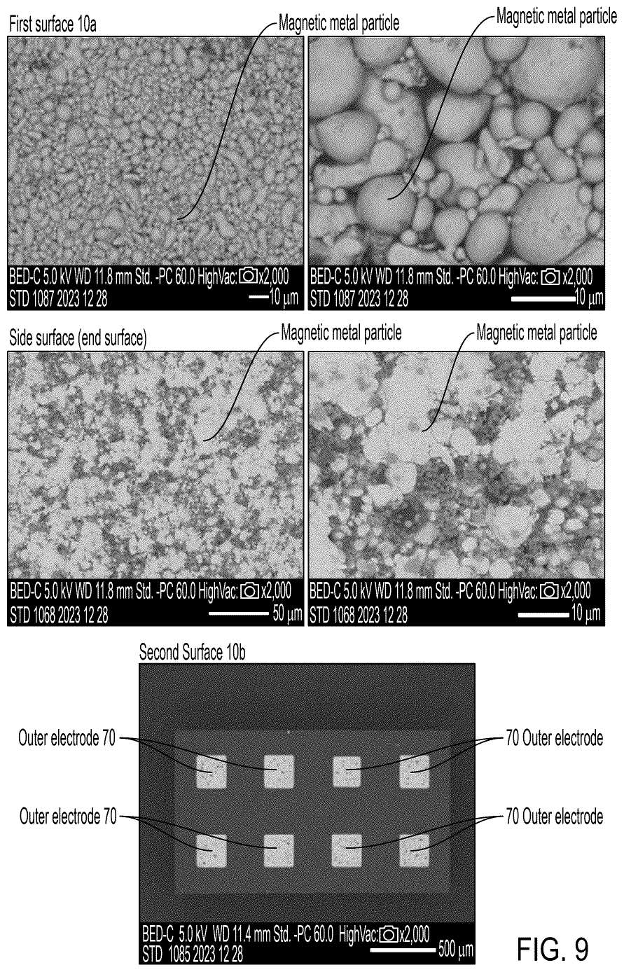

According to the present embodiment, as illustrated in the photographic images in FIGS. 8 and 9, the brightness of the first surface 10a is higher than the brightness of the first end surface 10c, the second end surface 10d, the first side surface 10e, and the second side surface 10f. According to the present embodiment, the degree of oxidation of the magnetic metal particles that form the first surface 10a is higher than the degree of oxidation of the magnetic metal particles that form the first end surface 10c, the second end surface 10d, the first side surface 10e, and the second side surface 10f.

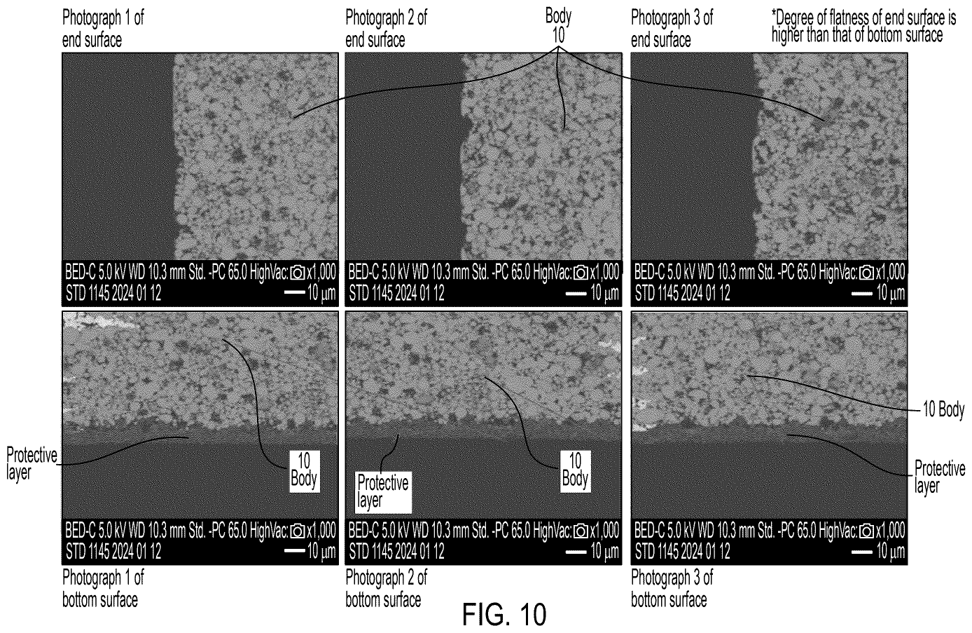

According to the present embodiment, as illustrated in the photographic images of FIG. 10, the magnetic metal particles that form the first end surface 10c, the second end surface 10d, the first side surface 10e, and the second side surface 10f are broken. That is, the degree of sphericity of the magnetic metal particles that form the first surface 10a is higher than that of the magnetic metal particles that form the first end surface 10c, the second end surface 10d, the first side surface 10e, and the second side surface 10f. Sphericity is obtained, for example, by analyzing SEM images of each surface using image analysis software (For example, image analysis software WinROOF2021 (manufactured by Mitani Corporation)).

As illustrated in the photographic images of FIG. 10, the degree of flatness of the first and second end surfaces 10c and 10d is higher than that of the bottom surface 10b. That is, the surface roughness of the first end surface 10c and the second end surface 10d is smaller than the surface roughness of the bottom surface 10b. The surface roughness can be measured, for example, by a digital electron microscope such as VHX-6000 manufactured by Keyence.

According to the present embodiment, only the first surface 10a is covered by the resin that is filled in the body 10. That is, from the first surface 10a, metal particles are not exposed and are not cut. On the other hand, on the other surfaces such as the bottom surface 10b, the first end surface 10c, the second end surface 10d, the first side surface 10e, and the second side surface 10f, metal particles are cut and exposed.

### Coils

As discussed above, the coils of the multilayer inductor 1 according to the present embodiment include the first coil 20, the second coil 30, the third coil 40, and the fourth coil 50. In this example, the first coil 20 and the second coil 30 form a 2-in-1 coil. Also, in this example, the third coil 40 and the fourth coil 50 form a 2-in-1 coil. That is, the multilayer inductor 1 according to the present embodiment includes two sets of the 2-in-1 coils. A 2-in-1 coil described herein means two coils that are coaxially arranged, as would be understood in the art.

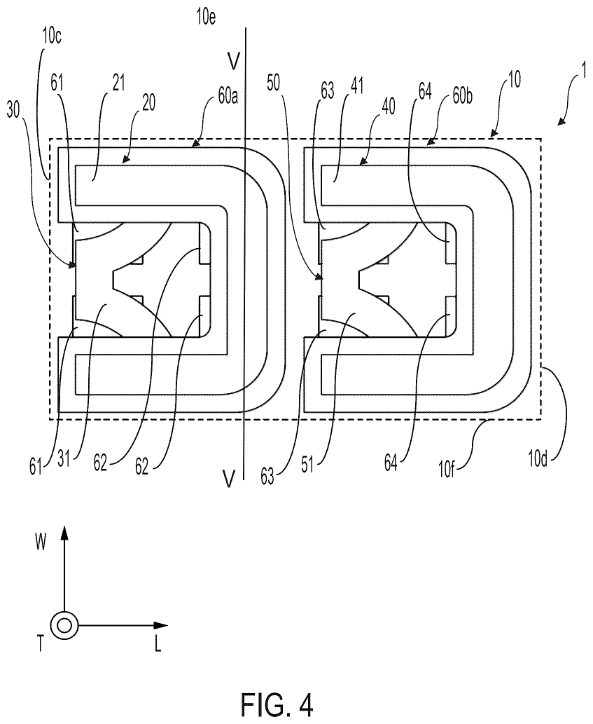

As illustrated in FIG. 1 and FIG. 4, the first connection portion 21 and the third connection portion 41 have a U-shape or a substantially U-shape. The second connection portion 31 has two sides 31-1 that extend in the W direction, two sides 31-2 that extend in the L direction, and two curves 31-3 that bend and avoid the first vias 22. The fourth connection portion 51 has two sides 51-1 that extend in the W direction, two sides 51-2 that extend in the L direction, and two curves 51-3 that bend and avoid the third vias 42. According to the present embodiment, the coils have a turn less than one. However, the coils can be configured to have one full turn or more than one full turn as appropriate.

As illustrated in FIG. 2, the first vias 22 are longer than the second vias 32. For this reason, the first connection portion 21 is located above the second connection portion 31 in the T direction in FIG. 2. The third vias 42 are longer than the fourth vias 52. For this reason, the third connection portion 41 is located above the fourth connection portion 51 in the T direction in FIG. 2. According to the present disclosure, the first coil 20 and the third coil 40 are referred to as upper coils in some cases. The second coil 30 and the fourth coil 50 are referred to as lower coils in some cases.

The distance between the first vias 22 is longer than the distance between the second vias 32, and the two second vias 32 are located between the two first vias 22 in the W direction. The two first vias 22 and the two second vias 32 are shifted from each other so as not to overlap in the W direction. The distance between the third vias 42 is longer than the distance between the fourth vias 52, and the two fourth vias 52 are located between the two third vias 42 in the W direction. The two third vias 42 and the two fourth vias 52 are shifted from each other so as not to overlap in the W direction.

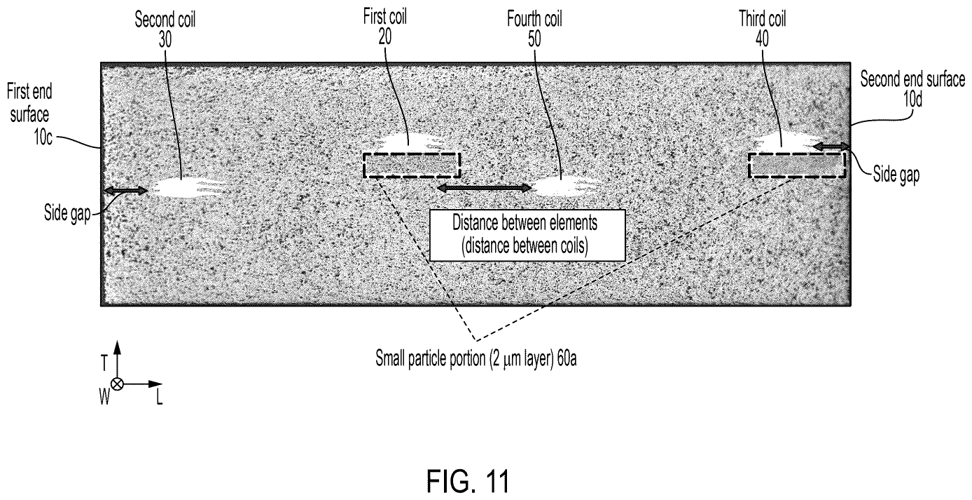

As illustrated in a photographic image in FIG. 11, the distance (a side gap) from the second coil 30 to the first end surface 10c in the L direction is shorter than the distance (the distance between elements) between the first coil 20 and the fourth coil 50 in the L direction. The distance (a side gap) from the third coil 40 to the second end surface 10d in the L direction is shorter than the distance (the distance between elements) between the first coil 20 and the fourth coil 50 in the L direction. Ratios between the side gaps and the distances between the elements are preferably two times or more, but can be any suitable distances as appropriate.

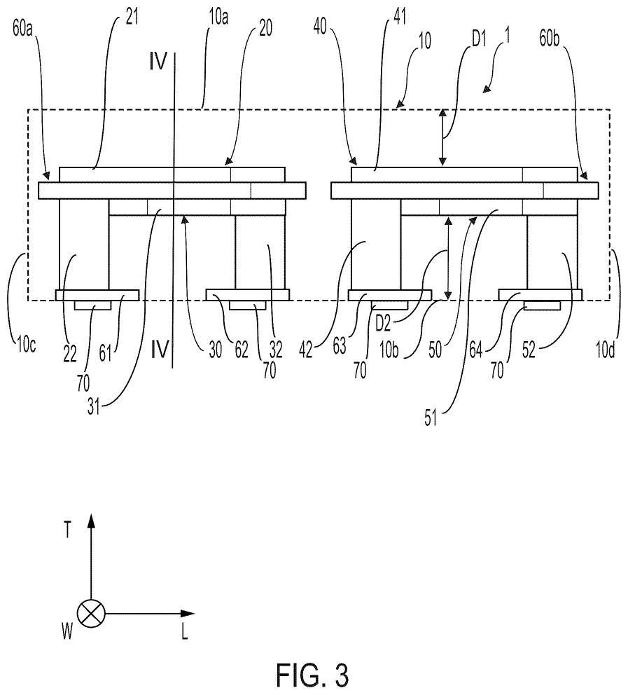

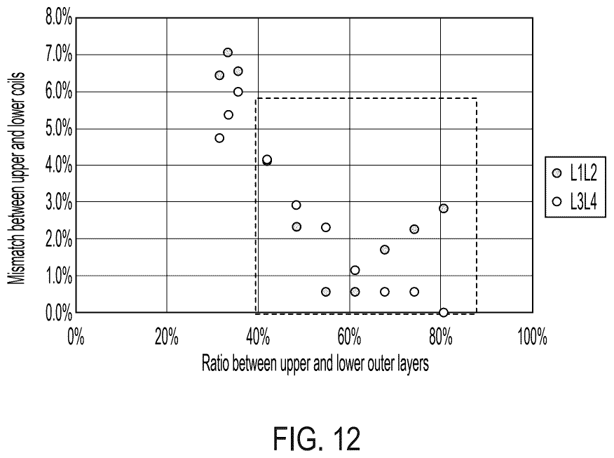

The coils are composed of highly conductive metal such as Cu or Ag. According to the present embodiment, the coils are composed of Ag. The first connection portion 21 of the first coil 20 and the third connection portion 41 of the third coil 40 are located at positions close to the first surface 10a (upper surface 10a) of the body as shown, for example, in FIG. 3 in the T direction. Specifically, a distance D1 from the third connection portion 41 to the first surface 10a (upper surface 10a) of the body 10 is shorter than a distance D2 from the fourth connection portion 51 to the second surface 10b (bottom surface 10b) of the body 10. Similarly, a distance D1 from the first connection portion 21 to the first surface 10a (upper surface 10a) of the body 10 is shorter than a distance D2 from the second connection portion 31 to the second surface 10b (bottom surface 10b) of the body 10. This enables the L values of the upper coils (first coil 20 and third coil 40) and the lower coils (second coil 30 and fourth coil 50) to approach each other. The ratio (the ratio between the upper and lower outer layers) of the distance D1 from the third connection portion 41 to the first surface 10a to the distance D2 from the fourth connection portion 51 to the second surface 10b preferably ranges from 0.4 to 0.8, but can be any suitable range, as appropriate. This enables the difference (L1L2) between the L values of the first coil 20 and the second coil 30 and the difference (L3L4) between the L values of the third coil 40 and the fourth coil 50 to be within about 4% as illustrated in a graph as shown in FIG. 12. It is noted that this L value is a value when one side of the first coil 20 is open and one side of the third coil 40 is open. Also, Table 3 below illustrates exemplary values associated with the graph shown in FIG. 12.

TABLE 3

| Ratio Between | Upper | Lower | Mismatch | Mismatch |
|---|---|---|---|---|
| Upper and | Outer | Outer | Between Upper | Between Upper |
| Lower Outer | Layer | Layer | and Lower | and Lower |
| Layers | (μm) | (μm) | Coils L1L2 | Coils L3L4 |
| 31% | 110 | 350 | 6.4% | 4.7% |
| 33% | 110 | 330 | 7.1% | 5.4% |
| 35% | 110 | 310 | 6.5% | 6.0% |
| 42% | 130 | 310 | 4.1% | 4.1% |
| 48% | 150 | 310 | 2.3% | 2.9% |
| 55% | 170 | 310 | 0.6% | 2.3% |
| 61% | 190 | 310 | 0.6% | 1.2% |
| 68% | 210 | 310 | 1.7% | 0.6% |
| 74% | 230 | 310 | 2.3% | 0.6% |
| 81% | 250 | 310 | 2.8% | 0.0% |

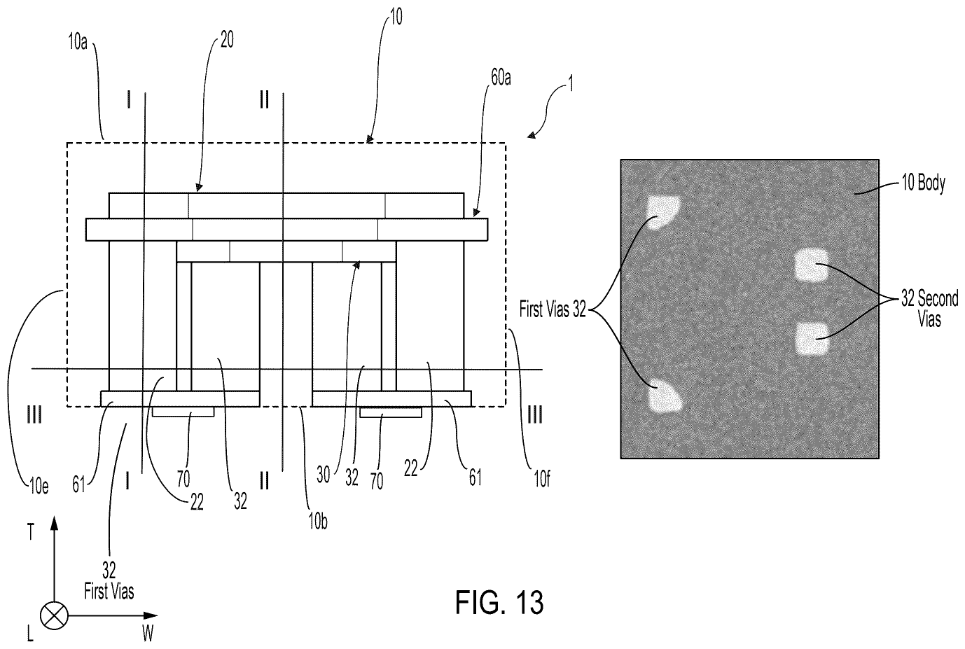

As illustrated in a photographic image in FIG. 13, a sectional shape of each first via 22 on a WT plane is a sectorial shape an arc of which faces inward in the body 10. This enables the L value of the second coil 30 to be increased and enables the insulation characteristics between the first coil 20 and the second coil 30 to be improved.

As illustrated in the photographic image in FIG. 13, a sectional shape of each second via 32 on the WT plane is a rectangular shape. The shapes of each first via 22 and each second via 32 may differ from each other as above. A sectional shape of each third via 42 on the WT plane may be a sectorial shape an arc of which faces inward in the body, and a sectional shape of each fourth via 52 on the WT plane may be a rectangular shape. That is, the shapes of each third via 42 and each fourth via 52 may differ from each other.

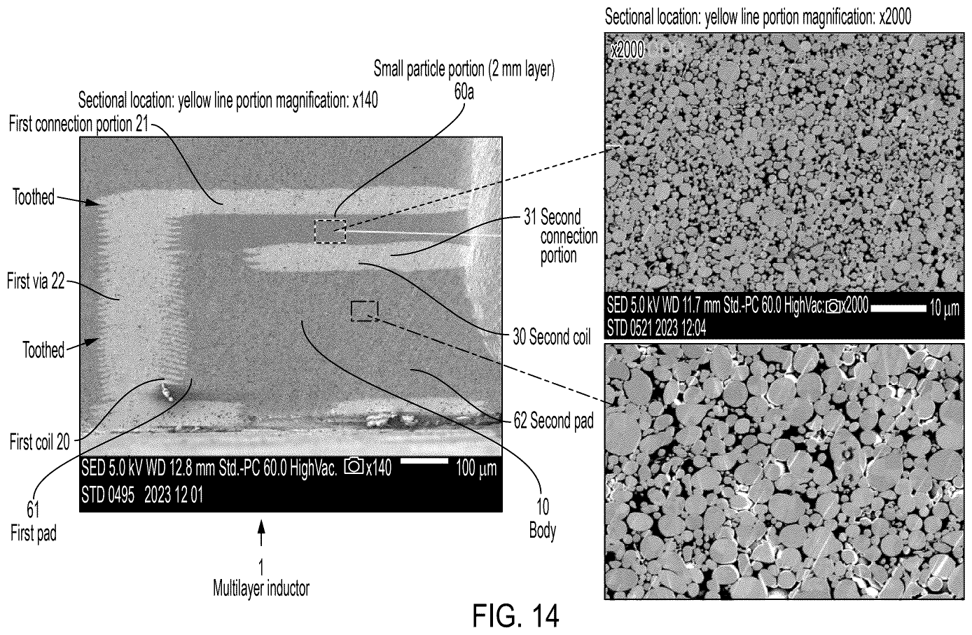

As illustrated in the photographic images in FIG. 14, which is a cross-section taken along lines I-I in FIG. 2, a section of each via (the first via 22 is shown as an example) on an LT plane has a shape (a saw shape) having a toothed side. Also, a section of each connection portion has a shape (a saw shape) having a toothed side as illustrated in the photographic images in FIG. 14.

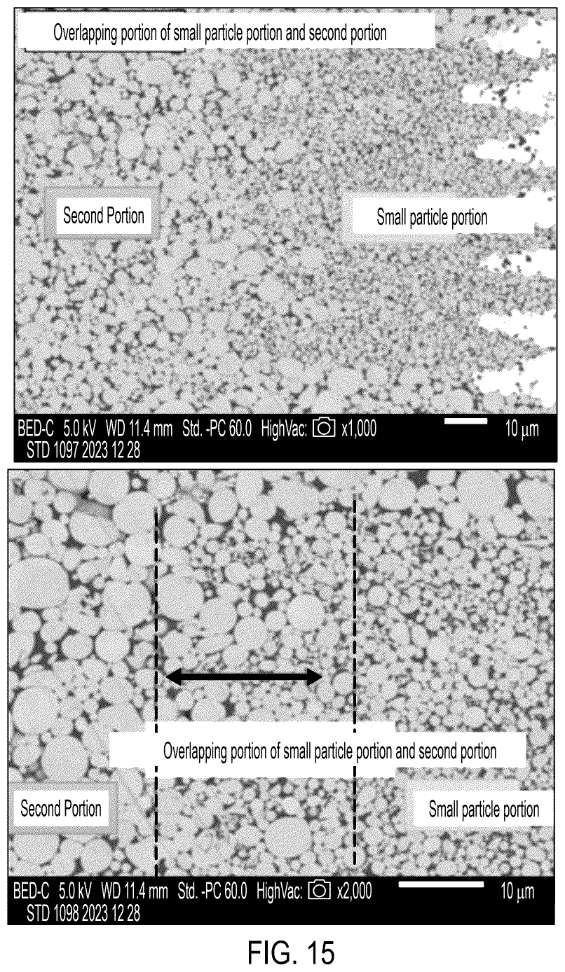

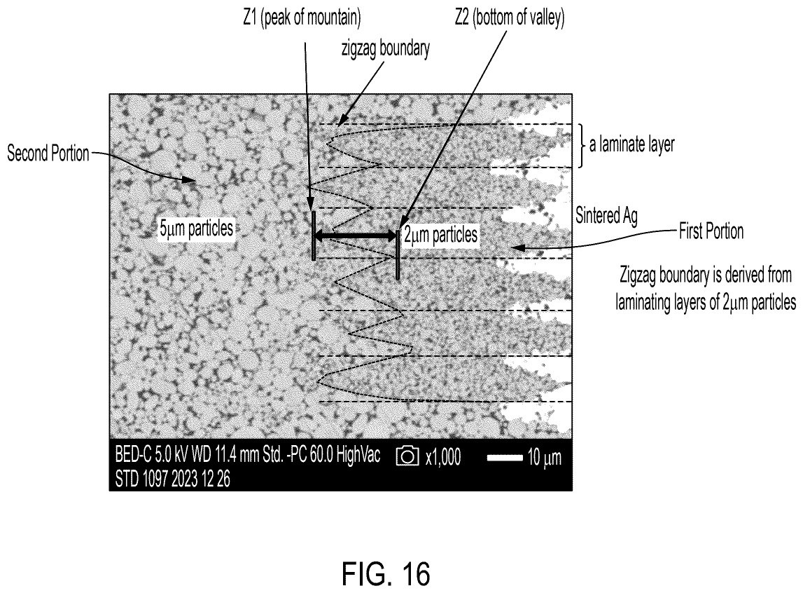

It is noted the body 10 includes the first portion 60a and the second portion. The second portion includes metal magnetic particles having a larger average particle diameter than that of metal magnetic particles in the first portion 60a. Also, sections of small particle portions 60a and 60b described later have toothed sides as illustrated in photographic images in FIGS. 15 and 16. That is, in regions in which the small particle portions 60a and 60b are in contact with the body 10, the small particle portion 60a and the second portion mesh with each other, and the small particle portion 60b and the body 10 mesh with each other. This mesh, which can also be referred to as an overlapping portion, preferably occurs in a range of 20 to 100 μm in the L direction or in a range of 20 to 100 μm in the W direction. However, this mesh or overlapping portion can occur within any suitable range, as appropriate. Thus, for example, a first portion is in the body 10 between the first coil 20 and the second coil 30 in the stacking direction of the first coil 20 and the second coil 30, and the first portion extends between the first coil 20 and the second coil 30 along a first direction, such as direction L and direction W, which is transverse to the stacking direction. The first portion including second magnetic metal particles having a second diameter that is smaller than the first diameter, and a border area where the first portion and a second portion of the body 10 meet includes extending areas where the first portion extends further into the second portion of the body 10 along the first direction than other areas of the first portion in the border area such that the first portion and the second portion mesh with each other. Thus, as shown in the photographic image of FIG. 16, a boundary (zigzag boundary) between the first portion and the second portion in the border area has a zigzag shape viewed in a direction transverse to the stacking direction within zigzag border lines Z1 and Z2.

### Small Particle Portions (2 μm Layer)

As discussed above with regard to FIGS. 1-4, the multilayer inductor 1 according to the present embodiment includes the small particle portion 60a (2 μm layer) within the zigzag boundary between zigzag border lines Z1 and Z2 between the first coil 20 and the second coil 30. The zigzag boundary, as indicated by the double arrow line in FIG. 16 between zigzag border lines Z1 and Z2, extends in a range of 20 μm to 100 μm as discussed above between adjacent “mountains” and “valleys”. That is, the zigzag boundary can be within a range of 20 μm to 100 μm between the “peak” of a “mountain” and the “bottom” of a “valley” that are adjacent to each other as shown in FIG. 16 within the entire zigzag boundary area. The multilayer inductor 1 according to the present embodiment includes the small particle portion 60b (2 μm layer) between the third coil 40 and the fourth coil 50.

The small particle portions 60a and 60b contain magnetic metal particles having an average particle diameter smaller than that of the magnetic metal particles of the body 10. According to the present embodiment, the average particle diameter of the magnetic metal particles of the small particle portions 60a and 60b is 2 μm. However, the average particle diameter can be any suitable diameter, as appropriate. For this reason, according to the present disclosure, the small particle portions 60a and 60b are also referred to as 2 μm layers. The magnetic metal particles of the small particle portions 60a and 60b may be composed of the same material as the magnetic metal particles of the body 10 and may have insulating coatings on surfaces as in the magnetic metal particles of the body 10. According to the present embodiment, the small particle portions 60a and 60b are composed of Fe—Si alloy particles as in the body 10.

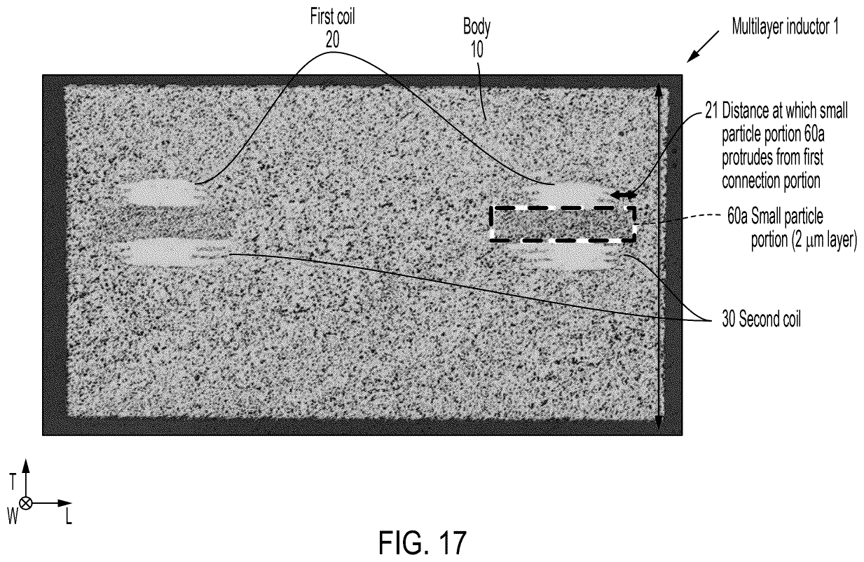

The small particle portion 60a is formed between the first coil 20 and the second coil 30. According to the present embodiment, the shape of the small particle portion 60a is a shape extending along the first connection portion 21. The small particle portion 60a is larger than the first connection portion 21 on a WL plane and protrudes from the first connection portion 21. This enables the insulation characteristics between the first coil 20 and the second coil 30 to be improved. As illustrated in a photographic image in FIG. 17, a distance at which the small particle portion 60a on the WL plane protrudes from the first connection portion 21 preferably ranges from 20 μm to 100 μm, but can be any suitable range, as appropriate. This enables the magnetic characteristics of the first coil 20 and the second coil 30 to be improved and enables the insulation characteristics between the two coils to be ensured. According to the present embodiment, the small particle portion 60a is not exposed from the body 10. This enables the magnetic characteristics of the multilayer inductor 1 to be improved. As discussed above, the first vias 22 extend through the small particle portion 60a, and the first vias 22 and the first connection portion 21 are in direct contact with each other.

The small particle portion 60b is formed between the third coil 40 and the fourth coil 50. According to the present embodiment, the shape of the small particle portion 60b is a shape extending along the third connection portion 41. The small particle portion 60b is larger than the third connection portion 41 on the WL plane and protrudes from the third connection portion 41. This enables the insulation characteristics between the third coil 40 and the fourth coil 50 to be improved. A distance at which the small particle portion 60b on the WL plane protrudes from the third connection portion 41 preferably ranges from 20 μm to 100 μm, but can be any suitable range, as appropriate. This enables the magnetic characteristics of the third coil 40 and the fourth coil 50 to be improved and enables the insulation characteristics between the two coils to be ensured. According to the present embodiment, the small particle portion 60b is not exposed from the body 10. This enables the magnetic characteristics of the multilayer inductor 1 to be improved. As discussed above, the third vias 42 extend through the small particle portion 60b, and the third vias 42 and the third connection portion 41 are in direct contact with each other.

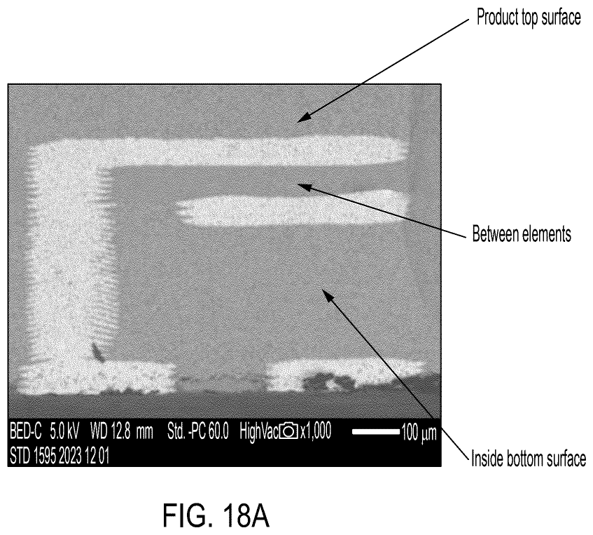

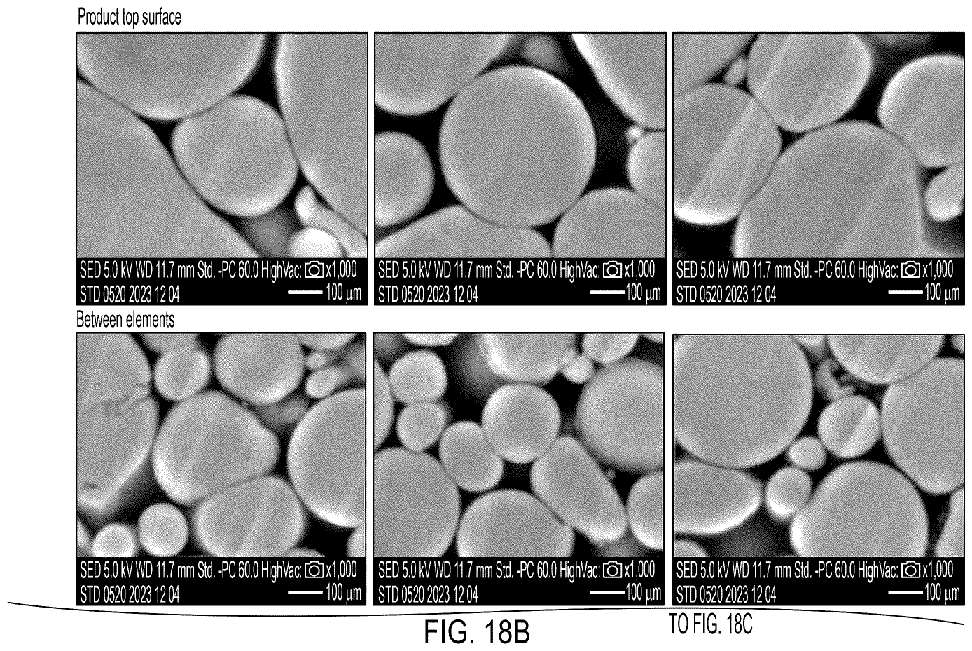

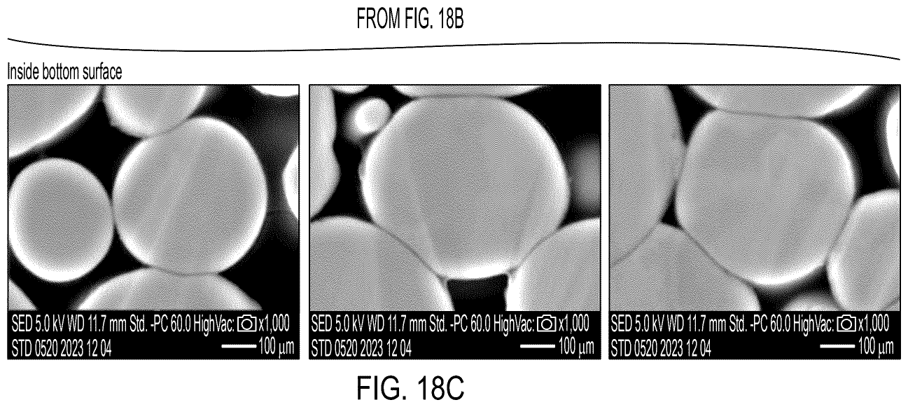

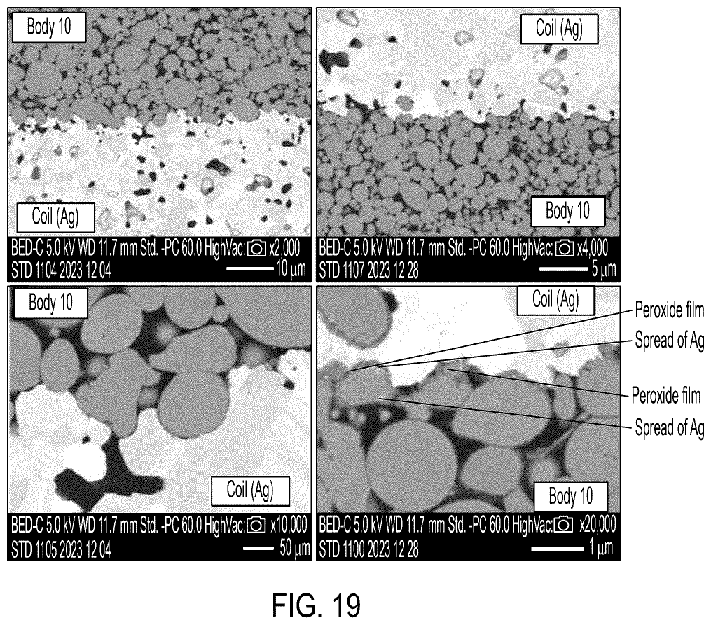

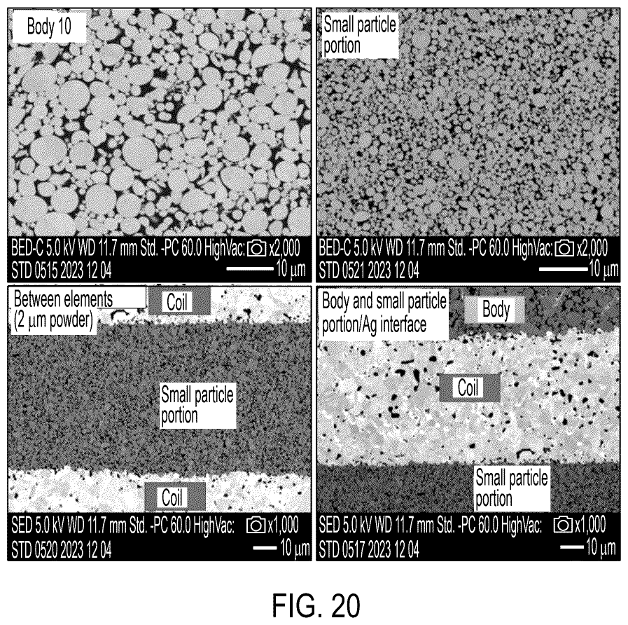

In addition, according to the present embodiments, oxide films are on the surfaces of the magnetic metal particles that are contained in the body 10 as discussed above and shown, for example, in the photographic images in FIGS. 18A to 18C. Also, as illustrated in the photographic images in FIGS. 19 and 20, peroxide films of the magnetic metal particles that form the body 10 and the small particle portions 60a and 60b may be present at portions (interfaces) of the body 10 and the small particle portions 60a and 60b that are in contact with the coils 20, 30, 40 and 50 and the vias 22, 32, 42 and 52. As illustrated in the photographic images in FIGS. 19 and 20, metal of the coils 20, 30, 40 and 50 and the vias 22, 32, 42 and 52, which is Ag according to the present embodiment (or any other suitable material), may diffuse to the magnetic metal particles at the portions (the interfaces) of the body 10 and the small particle portions 60a and 60b that are in contact with the coils 20, 30, 40 and 50 and the vias 22, 32, 42 and 52.

According to the present embodiment, as illustrated on the lower right photographic image of the photographic images in FIG. 20, extension from the body 10 is greater than extension to the small particle portions 61a and 61b as for the length of extension from the coils 20, 30, 40 and 50 in which Ag extends.

### Pads

On the WL plane, the sectional area of each pad 61, 62, 63 and 64 may be larger than the sectional area of each via 22, 32, 42 and 52. This enables the positions of the pads 61, 62, 63 and 64 and the vias 22, 32, 42 and 52 to be easily adjusted during electrical connection. The pads 61, 62, 63 and 64 may be composed of the same metal as the coils 20, 30, 40 and 50 and the vias 22, 32, 42 and 52 as discussed herein, or may be composed of any suitable material.

### Outer Electrodes

According to the present embodiment, as illustrated in the photographic images in FIG. 8, the outer electrodes 70 are provided only on the second surface 10b (bottom surface 10b) of the body 10. However, as discussed above, the outer electrodes 70 may be provided across the second surface 10b and another surface adjacent to the second surface 10b other than the second surface 10b of the body 10 (a surface or two surfaces) among the first end surface 10c, the second end surface 10d, the first side surface 10e, and the second side surface 10f.

In a preferable aspect for the outer electrodes 70, the areas of the outer electrodes 70 viewed from the mounting surface (e.g., bottom surface 10b) of the multilayer inductor 1 may be larger than the areas of the pads 61, 62, 63 and 64 that are connected thereto. This enables the positions of the pads 61, 62, 63 and 64 and the outer electrodes 70 to be easily adjusted during electrical connection.

Various materials such as Cu and/or Au may be used for the outer electrodes 70. The outer electrodes 70 may be formed in any manner and may be electrodes that are formed by using, for example, a plating method (such as an electroless plating method) or a sputtering method, and plating layers of, for example, Ni and Sn may be formed on the outer electrodes 70 by using the plating method after the outer electrodes 70 are formed such that a multilayer structure of two or more layers is obtained. According to the present embodiment, the outer electrodes 70 are formed with Cu by plating on the pads 61, 62, 63 and 64 that are exposed from the body 10.

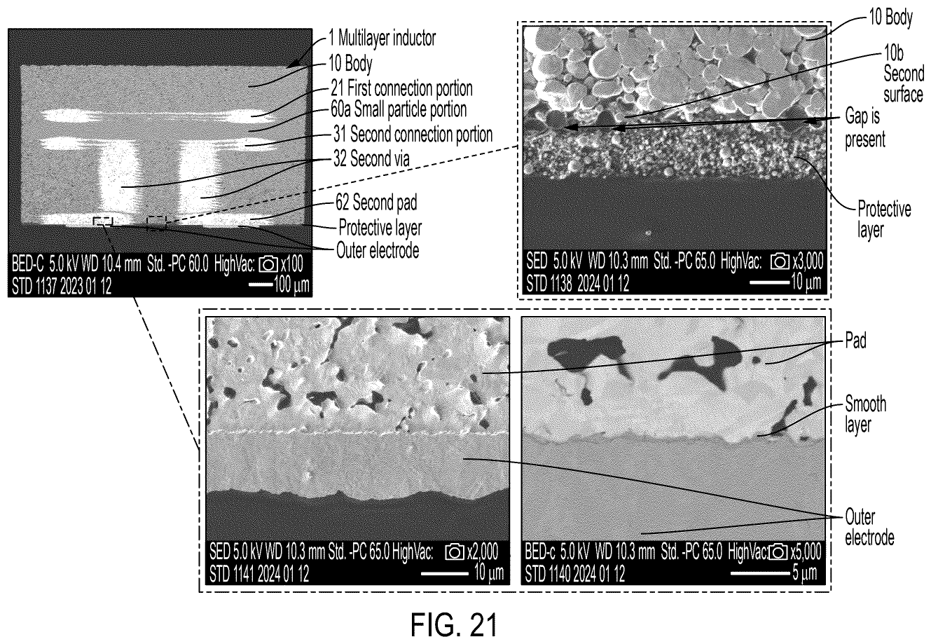

As illustrated in photographic images in FIG. 21, a smooth layer is formed between the pads 61, 62, 63 and 64 and the outer electrodes 70. Forming the smooth layer enables efficiency when the outer electrodes 70 are formed by plating to be improved. The surface of the smooth layer is less uneven than the surfaces of the pads. That is, the surface of the smooth layer has flatness higher than that of the surfaces of the pads. The smooth layer that contacts the pad contains Ag, for example, but can contain any other suitable material, such as Ag and Fe.

Thus, the exposed surface of the pad, such as each of pads 61, 62, 63 and 64, includes protruding portions and recessed portions. An outer electrode 70 that is on the surface 10b of the body 10 in this example, contacts the exposed surface of the pad 61, 62, 63 or 64 and is electrically connected to the pad 61, 62, 63 or 64, such that the protruding portions of the pad 61, 62, 63 or 64 extend into the outer electrode and portions of the outer electrode 70 extend into the recessed areas of the pad 61, 62, 63 or 64.

### Protective Layer

As illustrated in the photographic images in FIGS. 21, 22 and 23, the multilayer inductor 1 according to the present embodiment further includes a protective layer on the second surface 10b (the bottom surface 10b). According to the present embodiment, the protective layer is composed of resin and particles (specifically, silica particles) having the insulation characteristics. The protective layer has openings, and the pads 61, 62, 63 and 64 and the outer electrodes 70 are electrically connected through the openings. The openings are smaller than the pads 61, 62, 63 and 64. This enables the precision of the sizes of the outer electrodes 70 to be improved. According to the present embodiment, the protective layer has the multiple openings, specifically the openings the number of which is the same as the number of the outer electrodes 70 the same as the number of the outer electrodes 70.

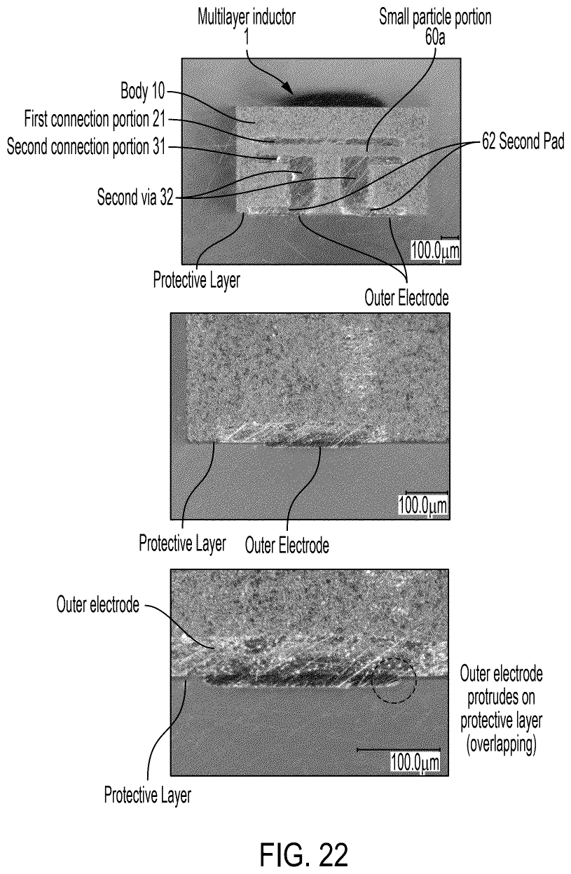

As illustrated in the photographic images in FIG. 22, the outer electrodes 70 are formed on the protective layer so as to protrude. As illustrated in the photographic image in the upper right hand corner of the photographic images in FIG. 21, spherical gaps are formed between the protective layer and the second surface 10b (bottom surface 10b) of the body 10.

### Method of Manufacturing Multilayer Inductor 1

The multilayer inductor 1 according to the present embodiment is manufactured in a manner in which magnetic paste for forming the body 10, conductive paste for forming the coils 20, 30, 40 and 50, the vias 22, 32, 42 and 52, and the pads 61, 62, 63 and 64, and the magnetic, small-particle paste for forming the small particle portions 61a and 61b are printed in respective desired patterns, sheets are formed, and a block created by stacking the sheets is fired. The multilayer inductor 1 can be formed in a manner in which resin is impregnated in the body 10 obtained by firing the block, and the protective layer and the outer electrodes 70 are formed.

The magnetic paste is composed of magnetic metal particles and resin. The magnetic, small-particle paste is composed of magnetic metal particles having an average particle diameter smaller than that of the magnetic metal particles of the magnetic paste and resin. The conductive paste is composed of metal particles of, for example, Cu or Ag and resin. A method of forming the sheets is not particularly limited. For example, the sheets may be formed by being dried after printing in a printing method such as a coat printing method or a sheet printing method. In addition, a method of manufacturing inductor 1 is not limited to using sheets and may be a printing lamination method.

The multilayer inductor according to the present disclosure is not limited to a structure described later and may be appropriately modified without departing from the spirit of the present disclosure. A combination of multiple preferable components described later is also included in the present disclosure. Also, in the present specification, words (such as “parallel”, “perpendicular”, and “vertical”) that represent relationships among elements and words that represent the shapes of the elements mean not only literally strict aspects but also substantially equivalent ranges such as ranges including a difference of about several %.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. An inductor comprising:
a body including a resin that includes first magnetic metal particles having a first diameter;
a first coil and a second coil inside the body in a stacking direction; and
a first portion in the body between the first coil and the second coil in the stacking direction of the first coil and the second coil, the first portion extending between the first coil and the second coil along a first direction which is transverse to the stacking direction, the first portion including second magnetic metal particles having a second diameter that is smaller than the first diameter, and a border area where the first portion and a second portion of the body meet includes extending areas where the first portion extends further into the second portion of the body along the first direction than other areas of the first portion in the border area such that the first portion and the second portion mesh with each other.

2. The inductor according to claim 1, wherein
the border area extends within a range of 20 μm to 100 μm along the first direction.

3. The inductor according to claim 1, wherein
the border area further extends in a second direction transverse to the first direction and the stacking direction.

4. The inductor according to claim 3, wherein
the border area extends within a range of 20 μm to 100 μm along the second direction.

5. The inductor according to claim 1, wherein
a boundary between the first portion and the second portion in the border area has a zigzag shape viewed in a direction transverse to the stacking direction.

6. The inductor according to claim 1, wherein
a resin filling rate of the resin in the first portion is lower than a resin filling rates of the body above the first coil and the body below the second coil in the stacking direction.

7. The inductor according to claim 1, wherein
a first surface of the body that is above the first coil in the stacking direction is covered by the resin that is filled in the body.

8. The inductor according to claim 1, wherein
the first coil includes at least one first via that extends in the stacking direction to a surface of the body; and
the second coil includes at least one second via that extends in the stacking direction a surface of the body,
wherein each of the at least one first via is longer than each of the at least one second via.

9. The inductor according to claim 8, wherein
the at least one first via is two first vias;
the at least one second via is two second vias; and
as viewed facing the body in the stacking direction, a distance between the first vias is longer than a distance between the second vias, and such that second vias are between the first vias.

10. The inductor according to claim 1, wherein
the first coil includes at least one first via that extends in the stacking direction to a surface of the body,
wherein as viewed facing the body in the stacking direction, a sectional shape of each of the at least one first via is an arcuate shape facing inward in the body.

11. The inductor according to claim 1, wherein
the second coil includes at least one second via that extends in the stacking direction to a surface of the body,
wherein as viewed facing the body in the stacking direction, a sectional shape of each of the at least one second via is rectangular.

12. The inductor according to claim 1, wherein
at least one of
the first coil includes a first via that extends in the stacking direction to a surface of the body; or
the second coil includes a second via that extends in the stacking direction to a surface of the body,
wherein the first magnetic metal particles in the body and the second magnetic metal particles in the first portion include a peroxide film, and a metal in at least one of the first coil, the second coil, the first via or the second via diffuses with at least one of the first magnetic metal particles or the second magnetic particles.

13. The inductor according to claim 1, wherein
the first coil includes a first connection portion and the second coil includes a second connection portion, and
the first coil connection portion is shorter than the second connection portion.

14. The inductor according to claim 1, further comprising:
a first pad on a surface of the body that is electrically connected to the first coil, and an outer surface of the first pad includes protruding portions and recessed portions; and
a first outer electrode that is on the surface of the body, the first outer electrode extends onto the first pad and is electrically connected to the first pad, such that the protruding portions of the first pad extend into the first outer electrode and portions of the first outer electrode extend into the recessed areas of the first pad.

15. The inductor according to claim 1, wherein
the body has a first outer surface and a second outer surface opposite to each other in the stacking direction; and
a first distance between the first outer surface and a first surface of the first coil facing the first outer surface is less than a second distance between the second outer surface and a second surface of the second coil facing the second outer surface.

16. The inductor according to claim 1, further comprising:
a third coil and a fourth coil inside the body in the stacking direction, and spaced from the first coil and the second coil in a direction transverse to the stacking direction; and
a third portion in the body between the third coil and the fourth coil in the stacking direction of the third coil and the fourth coil, the portion extending between the third coil and the fourth coil along the first direction, the third portion including third magnetic metal particles having a third diameter that is smaller than the first diameter, and a second border area where the third portion and a fourth portion of the body meet includes extending areas where the third portion extends further into the fourth portion of the body along the first direction than other areas of the third portion in the border area such that the third portion and the fourth portion mesh with each other.

17. An inductor comprising:
a body including a resin that includes magnetic metal particles;
a coil inside the body;
a pad on a surface of the body that is electrically connected to the coil, and an outer surface of the pad includes protruding portions and recessed portions; and
an outer electrode that is on the surface of the body, the outer electrode contacts the outer surface of the pad and is electrically connected to the pad, such that the protruding portions of the pad extend into the outer electrode and portions of the outer electrode extend into the recessed portions of the pad.

18. The inductor according to claim 17, wherein
a surface of the outer electrode that contacts the pad has a flatness higher than a flatness of the outer surface of the pad.

19. The inductor according to claim 17, wherein
a surface of the outer electrode that contacts the pad includes at least one of Ag and Fe.

20. The inductor according to claim 17, further comprising:
a second coil inside the body; and
a first portion in the body between the coil and the second coil in a stacking direction of the coil and the second coil, the portion including second magnetic metal particles having a second diameter that is smaller than a first diameter of the magnetic metal particles in the body, and a border area where the first portion and a second portion of the body meet includes extending areas where the first portion extends further into the second portion of the body along the first direction than other areas of the first portion in the border area such that the first portion and the second portion mesh with each other.
